(19) United States
(12) Patent Application Publication
(10) Pub. No.: US 2026/0151710 A1
(43) Pub. Date: Jun. 4, 2026

(54) INFORMATION DISPLAY METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Ziqi WEI, Shenzhen (CN)

(21) Appl. No.: 19/455,240

(22) Filed: Jan. 21, 2026

Related U.S. Application Data
(63) Continuation of application No. PCT/CN2024/123902, filed on Oct. 10, 2024.

(30) Foreign Application Priority Data
Dec. 26, 2023 (CN) 202311818694.5

(51) Int. Cl. A63F 13/69; A63F 13/533; A63F 13/79; A63F 13/822

(52) U.S. Cl. CPC A63F 13/69; A63F 13/533; A63F 13/79; A63F 13/822

(57) ABSTRACT

An information display method includes: displaying a match interface between a host account and an opponent account in a board game; displaying quantity information of a first virtual piece in response to receiving a selection operation for the first virtual piece in a plurality of virtual pieces; and updating and displaying, in response to an exchange event of the host account or the opponent account for the first virtual piece, the quantity information corresponding to the first virtual piece.

### CROSS-REFERENCES TO RELATED APPLICATIONS

The present disclosure is a continuation of PCT Application No. PCT/CN 2024/123902, filed on Oct. 10, 2024, which claims priority to Chinese Patent Application No. 202311818694.5, entitled “INFORMATION DISPLAY METHOD AND APPARATUS, DEVICE, MEDIUM, AND PROGRAM PRODUCT” and filed on Dec. 26, 2023, the entire contents of all of which are incorporated herein by reference.

### FIELD OF THE TECHNOLOGY

Embodiments of the present disclosure relate to the field of computer technologies, and in particular, to an information display method and apparatus, a device, a medium, and a program product.

### BACKGROUND OF THE DISCLOSURE

An auto battler is a genre of tactical strategy video games that typically feature chess-like elements. The gameplay of the auto battler is as follows: a match begins with pairing between player accounts. Before the match starts, the players place virtual pieces on a grid-like game battlefield in a virtual scene. During the match, the virtual pieces corresponding to different accounts automatically engage in game battle without the need for further operations of the players. Therefore, a quantity of each type of virtual piece in the match can serve as reference information to help the players to arrange the virtual pieces engaging in game battle.

A player may observe a quantity and types of virtual pieces owned by an opponent, to determine a quantity and types of virtual pieces used when engaging in virtual game battle, and to plan locations of the virtual pieces in a virtual scene.

However, during a gaming process of the auto battler, a quantity of each type of virtual piece changes in real time. When the opponent adjusts the virtual piece, the quantity of virtual pieces needs to be recalculated. Therefore, the player memorizes and collects statistics on the quantity of each type of virtual piece. This method has low efficiency and low accuracy.

### SUMMARY

Embodiments of the present disclosure provide an information display method and apparatus, a device, a medium, and a program product, to display quantity information and a change process of a virtual piece in real time. The technical solutions are as follows:

In an aspect, an information display method is provided, performed by a computer device. The method includes: displaying a match interface between a host account and an opponent account in a board game, the match interface including a plurality of virtual pieces, a host virtual piece being a virtual piece redeemed by the host account, and the host virtual piece being configured to engage in virtual game battle against an opponent virtual piece redeemed by the opponent account; displaying quantity information of a first virtual piece in response to receiving a selection operation for the first virtual piece in the plurality of virtual pieces, the quantity information including a total quantity of first virtual pieces redeemed by the host account and the opponent account; and updating and displaying, in response to an exchange event of the host account or the opponent account for the first virtual piece, the quantity information corresponding to the first virtual piece.

In another aspect, an information display apparatus is provided. The apparatus includes: a display module, configured to display a match interface between a host account and an opponent account in a board game, the match interface including a plurality of virtual pieces; a host virtual piece being a virtual piece redeemed by the host account, and the host virtual piece being configured to engage in virtual game battle against an opponent virtual piece redeemed by the opponent account, the display module being further configured to display quantity information of a first virtual piece in response to receiving a selection operation for the first virtual piece in the plurality of virtual pieces, the quantity information including a total quantity of first virtual pieces redeemed by the host account and the opponent account; and an update display module, configured to update and display, in response to an exchange event of the host account or the opponent account for the first virtual piece, the quantity information corresponding to the first virtual piece.

In another aspect, a computer device is provided. The computer device includes a processor and a memory. The memory has at least one instruction, at least one program, a code set, or an instruction set stored therein, and the at least one instruction, the at least one program, the code set, or the instruction set is loaded and executed by the processor to implement the foregoing information display method according to any one of the embodiments of the present disclosure.

In another aspect, a non-transitory computer-readable storage medium is provided. The storage medium has at least one instruction, at least one program, a code set, or an instruction set stored therein, and the at least one instruction, the at least one program, the code set, or the instruction set is loaded and executed by a processor to implement the foregoing information display method according to any one of the embodiments of the present disclosure.

The technical solutions provided in the embodiments of the present disclosure achieve at least the following beneficial effects:

On the match interface of the board game, the quantity information of the virtual piece can be displayed based on the selection operation for the virtual piece without the need of memorizing by a player. The quantity information includes the total quantity of virtual pieces redeemed by the host account and the opponent account on the match interface. The quantity information not only allows the player to understand strength of both sides in a current match timely, but also can reflect a quantity of remaining virtual pieces that can be obtained through exchange, whereby more detailed prompt information is provided for the player to control the virtual piece to engage in virtual game battle. When the exchange event for the virtual piece occurs, the quantity information of the virtual piece is updated in real time, whereby the change in the quantity of virtual pieces can be prompted timely. This not only significantly enhances human-computer interaction efficiency of the player, but also can enhance efficiency and accuracy of a statistical result of the quantity information.

### BRIEF DESCRIPTION OF THE DRAWINGS

FIG. 1 is a structural block diagram of an electronic device according to an exemplary embodiment of the present disclosure.

FIG. 2 is a structural block diagram of a computer system according to an exemplary embodiment of the present disclosure.

FIG. 3 is a flowchart of an information display method according to an exemplary embodiment of the present disclosure.

FIG. 4 is a schematic diagram of a match interface according to an exemplary embodiment of the present disclosure.

FIG. 5 is a schematic process diagram of persistently displaying quantity information according to an exemplary embodiment of the present disclosure.

FIG. 6 is a schematic process diagram of viewing quantity information in a persistent display area according to an exemplary embodiment of the present disclosure.

FIG. 7 is a schematic process diagram of canceling display of quantity information according to an exemplary embodiment of the present disclosure.

FIG. 8 is a schematic process diagram of selecting and viewing quantity information according to an exemplary embodiment of the present disclosure.

FIG. 9 is a flowchart of an information display method according to another exemplary embodiment of the present disclosure.

FIG. 10 is a schematic diagram of a change in quantity information before and after viewpoint switching according to an exemplary embodiment of the present disclosure.

FIG. 11 is a schematic diagram of selecting a first virtual piece after viewpoint switching according to an exemplary embodiment of the present disclosure.

FIG. 12 is a flowchart of a method for displaying quantity information of a high-tier virtual piece according to an exemplary embodiment of the present disclosure.

FIG. 13 is a structural block diagram of an information display apparatus according to an exemplary embodiment of the present disclosure.

FIG. 14 is a structural block diagram of an information display apparatus according to another exemplary embodiment of the present disclosure.

FIG. 15 is a structural block diagram of a computer device according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

First, the nouns involved in embodiments of the present disclosure are briefly introduced.

Turn-based board game: it refers to a board game where players pre-arrange their “pieces” before a match begins, and during the game battle, the “pieces” automatically engage in game battle based on their pre-determined layout. A “piece” is typically represented by a virtual character, and for example, may be referred to as a virtual hero. During the game battle, the virtual character automatically casts various skills for the game battle. The game battle typically is turn-based. When all “pieces” of one player are eliminated (that is, health points of a virtual character drop to zero), the party is determined as the loser of this round. In some embodiments, in addition to “chess-type virtual characters” engaging in game battle, both sides are respectively provided with one player character representing a current user engaging in game battle. The player character cannot be moved to a game battle area or a candidate piece area as a “piece”. The player character also has health points (or hit points). The health points of the player character is correspondingly reduced (loser of the game battle) or not changed (winner of the game battle) according to a game battle result of each round. When the health points of the player character drop to zero, the user corresponding to the player character exits the game battle, and the remaining users continue the game battle. In an embodiment, the turn-based board game includes an auto battler.

Auto battler (also referred to as auto chess): it is a genre of tactical strategy video games that typically feature chess-like elements, and in some sense can also be considered a war chess game. In a preparation stage, players place characters on a grid-like game battlefield, and then the characters automatically game battle against each other, typically without the need for further input operations of the players. These characters are also referred to as pieces.

In an auto battler game or an auto battler application program, players can control virtual pieces to engage in virtual game battle. The virtual piece includes at least one of a card-type piece and a three-dimensional piece. The card-type piece is presented in the form of a card, and the three-dimensional piece is presented by a virtual object or piece in a three-dimensional form. In a game battle preparation stage, players can select suitable virtual pieces in a game battle preparation area, and place the virtual pieces in a grid-like game battlefield. When entering a game battle stage after game battle preparation ends, the virtual pieces automatically engage in game battle without the need for further operations of the players.

In an embodiment, the virtual piece is obtained through exchange (i.e., redeemed) from a piece pool, and a total quantity of virtual pieces that can be obtained by players in the same virtual game battle through redemption from the piece pool is limited. For example, there are eight player accounts in the virtual game battle, and an exchangeable/redeemable quantity of first virtual pieces is 10, which indicates that the total quantity of first virtual pieces that can be obtained through redemption by the eight player accounts is 10 at most.

Because the players do not need to perform an additional output operation in the auto battler game, and only need to setup the layout of the virtual pieces before the virtual game battle, types of virtual pieces owned by different player accounts in the game battle and a quantity of each type of virtual piece serve as prompt information to help the players to configure the layout.

The present disclosure provides an information display method, to intuitively prompt a quantity of selected virtual pieces in either a persistent display manner or a trigger display manner.

A match interface is displayed on a screen of a terminal, and the match interface includes a plurality of virtual pieces and a quantity display control. The quantity display control corresponds to a persistent display area. After the quantity display control is triggered, a selected first virtual piece is determined from the plurality of virtual pieces, and quantity information of the first virtual piece is displayed in the persistent display area in real time. When an exchange event for the first virtual piece occurs, the quantity information in the persistent display area is updated in real time.

Each virtual piece corresponds to a piece information display area. After the first virtual piece is triggered, piece information of the first virtual piece is displayed in the piece information display area of the first virtual piece. The piece information includes the quantity information of the first piece. Quantity information of the first virtual piece at a current moment is displayed each time the first virtual piece is triggered. When an exchange event for the first virtual piece occurs, updated quantity information is displayed when the first virtual piece is triggered next time.

The terminal in the present disclosure may be a desktop computer, a laptop computer, a mobile phone, a tablet computer, an e-book reader, a Moving Picture Experts Group Audio Layer III (MP3) player, a Moving Picture Experts Group Audio Layer IV (MP4) player, or the like. The terminal is equipped with and runs an application program supporting a virtual scene, such as an application program supporting a three-dimensional virtual scene. The application program may be any one of a virtual reality application program, a three-dimensional map program, a simulation game (SLG), and a multiplayer online game battle arena (MOBA) game. In an embodiment, the application program may be a standalone application program such as a standalone three-dimensional game program; or may be an online application program.

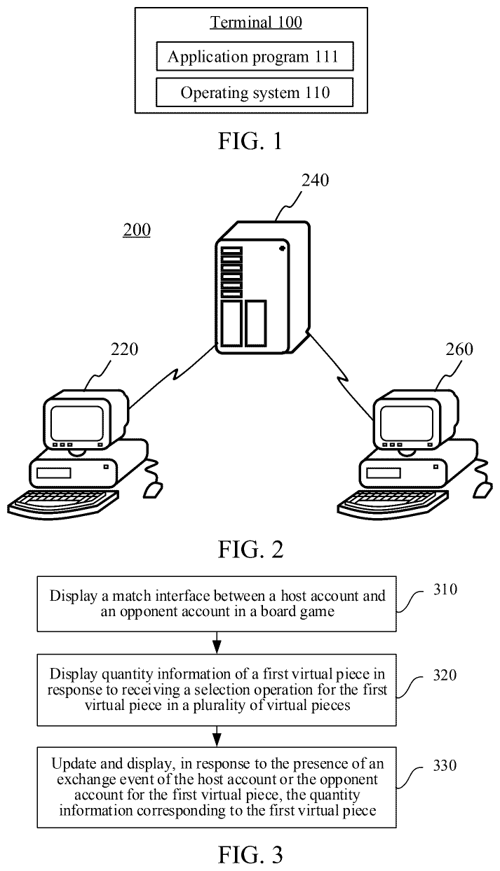

FIG. 1 is a structural block diagram of an electronic device according to an exemplary embodiment of the present disclosure. An electronic device 100 includes: an operating system 110 and an application program 111.

The operating system 110 is basic software provided for the application program 111 to perform secure access to computer hardware.

The application program 111 is an application program supporting a virtual scene. In an embodiment, the application program 111 is an application program supporting a three-dimensional virtual scene. The application program 111 may be any one of a virtual reality application program, a three-dimensional map program, a third-person shooter (TPS), a first-person shooter (FPS), an MOBA game, an SLG, and the like. The application program 111 may be a standalone application program such as a standalone three-dimensional game program; or may be an online application program.

FIG. 2 is a structural block diagram of a computer system according to an exemplary embodiment of the present disclosure. A computer system 200 includes: a first device 220, a server 240, and a second device 260.

The first device 220 is equipped with and runs an application program supporting a virtual scene. The application program may be any one of a virtual reality application program, a three-dimensional map program, a TPS, an FPS, an MOBA game, and an SLG. The first device 220 is a device used by a first user. The first user uses the first device 220 to control a host virtual object in a virtual scene to perform activities. The activities include, but are not limited to, at least one of adjusting a body posture, walking, running, and jump attacking. Exemplarily, the host virtual object is a host virtual person such as a simulated person character or a cartoon person character.

The first device 220 is connected to the server 240 by using a wireless network or a wired network.

The server 240 includes at least one of one server, a plurality of servers, a cloud computing platform, and a virtualization center. The server 240 is configured to provide a backend service for an application program supporting a three-dimensional virtual scene. In an embodiment, the server 240 undertakes primary computing work, and the first device 220 and the second device 260 undertake secondary computing work. Alternatively, the server 240 undertakes secondary computing work, and the first device 220 and the second device 260 undertake primary computing work. Alternatively, the server 240, the first device 220, and the second device 260 employ a distributed computing architecture for collaborative computation.

The second device 260 is equipped with and runs an application program supporting a virtual scene. The application program may be any one of a virtual reality application program, a three-dimensional map program, an FPS, a MOBA game, and an SLG. The second device 260 is a device used by a second user. The second user uses the second device 260 to control another virtual object in the virtual scene to perform activities. The activities include, but are not limited to, at least one of adjusting a body posture, walking, running, and jump attacking. Exemplarily, the another virtual object is another virtual person such as a simulated person character or a cartoon person character.

In an embodiment, the host virtual person and the another virtual person are located in the same virtual scene. In an embodiment, the host virtual person and the another virtual person may belong to the same team or the same organization, have a friend relationship, or have a temporary communication permission. In an embodiment, the host virtual person and the another virtual person may alternatively belong to different teams, different organizations, or two hostile groups.

In an embodiment, the application programs deployed on the first device 220 and the second device 260 are the same, or the application programs deployed on the two devices are the same type of application programs of different control system platforms. The first device 220 may generally refer to one of a plurality of devices, and the second device 260 may generally refer to one of a plurality of devices. In this embodiment, description is made by using only the first device 220 and the second device 260 as an example. A device type of the first device 220 may be the same as or different from a device type of the second device 260. In the following embodiments, a description is made by using an example in which the device is a desktop computer.

A person skilled in the art appreciate that there may be more or fewer devices. For example, there may be only one device, or there may be dozens of or hundreds of or more devices. The quantity of devices and the device type of the device are not limited in the embodiments of the present disclosure.

The server 240 may be implemented as a physical server, or may be implemented as a cloud server in a cloud. In some embodiments, the method provided in the embodiments of the present disclosure may be applied to a cloud game scene. In this case, a cloud server completes computing of data logic during a game, and a terminal is responsible for displaying a game interface.

The information display method provided in the present disclosure is described with reference to the foregoing brief noun introduction and application scenarios. The method may be performed by a server or a terminal alone, or may be performed by the server and the terminal collectively. In the embodiments of the present disclosure, a description is made by using an example in which the method is performed by a terminal. FIG. 3 is a flowchart of an information display method according to an exemplary embodiment of the present disclosure. The method includes the following operations:

Operation 310: Display a match interface between a host account and an opponent account in a board game.

The match interface includes a plurality of virtual pieces. A host virtual piece is a virtual piece redeemed by the host account, and the host virtual piece is configured to engage in virtual game battle against an opponent virtual piece redeemed by the opponent account. The plurality of virtual pieces includes at least one of the host virtual piece and the opponent virtual piece.

In an embodiment, the plurality of virtual pieces included in the match interface is the host virtual piece controlled by the host account; or the plurality of virtual pieces included in the match interface is the opponent virtual piece controlled by the opponent account; or the match interface includes a plurality of virtual pieces, one part of the virtual pieces are host virtual pieces controlled by the host account, and the other part of the virtual pieces are opponent virtual pieces controlled by the opponent account.

Exemplarily, the host account is an account logged in to a current terminal. For example, the host account is an account that logs in to a board game application program deployed on the current terminal; or the host account is an account that is logged in to a board game web page displayed by the currently terminal, or the like. The opponent account is an account that participates in an auto battler match with the host account in the board game. The opponent account is logged in to a terminal other than the current terminal, and is typically controlled by another player.

In some embodiments, the host account and the opponent account exchange for virtual pieces from a piece pool. The virtual piece obtained by the host account through exchange from the piece pool is the host virtual piece, and the virtual piece obtained by the opponent account through exchange from the piece pool is the opponent virtual piece.

In an embodiment, the piece pool includes a plurality of virtual pieces, and a quantity of each type of virtual piece is a preset value.

Exemplarily, the piece pool includes a total of 10 virtual pieces of Type A, a total of 18 virtual pieces of Type B, and the like. The host account and the opponent account can exchange for the virtual pieces from the piece pool by a method such as completing in-game tasks or collecting game props. For example, if the host account exchanges for two virtual pieces of Type A and one virtual piece of Type B, the two virtual pieces of Type A and the virtual piece of Type B serve as the host virtual pieces. If an opponent account D1 exchanges for one virtual piece of Type A, the virtual piece of Type A serves as the opponent virtual piece. If the host account and the opponent account D1 exchange for the foregoing virtual pieces only from the piece pool, the piece pool still includes seven virtual pieces of Type A and seventeen virtual pieces of Type B.

In an embodiment, a quantity of opponent accounts is 7, and both the host virtual piece and the opponent virtual pieces are virtual pieces obtained through exchange/redemption from the piece pool. On the match interface, eight player accounts (including the host account and the opponent accounts) are divided into four virtual matches, and each virtual match includes two player accounts. A virtual match conducted between the host account and the opponent account is taken as an example, the virtual match is presented on a terminal where the host account is logged in and a terminal where the opponent account is logged in.

In some embodiments, there is a duration requirement for match duration of each virtual match. For example, the match duration of each virtual match is at least one minute. If a first player account is eliminated when the match duration of the virtual match does not meet the duration requirement, the application program automatically matches a second player account that has not been eliminated with another account, to continue the virtual match.

Exemplarily, the another account includes at least one of a player account in another virtual match and a non-player account provided by the application program. When the another account is the non-player account, a type and a quantity of virtual pieces corresponding to the another account may be not preset, or may be preset. When the another account is the player account, a type and a quantity of virtual pieces corresponding to the another account are typically set by a player.

In an embodiment, the host account and the opponent account exchange for the virtual piece by obtaining a virtual resource. The virtual resource is a resource for exchanging for the virtual piece. A method for obtaining a virtual resource includes at least one of the following: (1) a virtual resource is obtained by completing an in-game task; (2) a virtual resource is obtained by collecting a virtual prop; (3) a virtual resource is obtained by winning a virtual match; (4) a virtual resource is obtained by meeting a preset requirement in a virtual match (for example, a virtual resource is obtained by performing combos in a virtual match); and the like.

Exemplarily, during a virtual match conducted between a virtual piece corresponding to the another account and the virtual piece of the second player account, the second player account obtains an additional virtual resource. Regardless of a result of the match between the second player account and the another account, the second player account remains in a non-eliminated state in the current virtual match.

The host account may use the virtual resource to redeem/exchange for a virtual piece from the piece pool, or the piece pool may reclaim a virtual piece redeemed by the host account, and the reclaimed virtual piece may be redeemed by the opponent account or obtained through re-redemption by the host account. If the host account uses a virtual resource A to exchange for a virtual piece from the piece pool, when the piece pool reclaims the virtual piece, the host account correspondingly reclaims the virtual resource A.

In some embodiments, the host account and the opponent account use the virtual resource to redeem/exchange for a virtual piece from a virtual store, and a quantity of virtual pieces obtained through exchange/redemption is limited. For example, each account can redeem five virtual pieces at most; or each account can redeem three virtual pieces of Type A at most and three virtual pieces of Type B at most.

Exemplarily, the virtual piece is obtained through exchange/redemption from the piece pool, the piece pool includes three types of virtual pieces, and a quantity of each type of virtual piece is 10. The host account and the opponent account may exchange for virtual pieces in the piece pool within a quantity limit set by the piece pool, to arrange the virtual pieces in the virtual match.

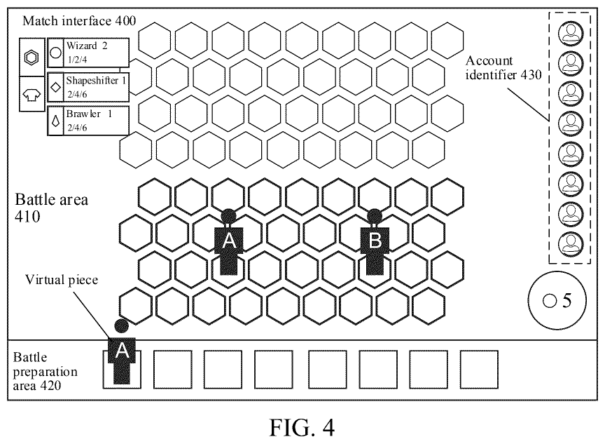

Exemplarily, FIG. 4 is a schematic diagram of one match interface.

A match interface 400 includes a game battle area 410 and a game battle preparation area 420. The game battle area 410 is an area where an auto battler match is conducted between an opponent account and a host account, and the game battle preparation area 420 is an area where the opponent account and the host account make preparations before the auto battler match starts.

The game battle area 410 and the game battle preparation area 420 include a plurality of virtual pieces. In a game battle preparation stage, the virtual piece in the game battle preparation area 420 may be placed in the game battle area 410 and may serve as a virtual piece used in the auto battler match, and the virtual piece in the game battle area 410 automatically engages in virtual battler when the auto battler match starts.

The match interface 400 further includes account identifiers 430 corresponding to all player accounts that participate in the auto battler match. The account identifiers 430 are configured for indicating different player accounts.

Operation 320: Display quantity information of a first virtual piece in response to receiving a selection operation for the first virtual piece in the plurality of virtual pieces.

In an embodiment, the plurality of virtual pieces includes at least one of the host virtual piece and the opponent virtual piece, and the first virtual piece is a selected virtual piece in the plurality of virtual pieces. For example, the first virtual piece is at least one host virtual piece, or the first virtual piece is at least one opponent virtual piece, or the first virtual piece is at least one host virtual piece and at least one opponent virtual piece.

In an embodiment, the selection operation includes at least one of a plurality of operation forms, such as a click/tap operation, a long-press operation, a slide operation, a drag operation, and a voice operation, for the first virtual piece. For example, the match interface includes one host virtual piece, which is a virtual piece A1 of Type A, and two opponent virtual pieces, which are a virtual piece A2 of Type A and a virtual piece B1 of Type B, respectively (the virtual piece A1 and the virtual piece A2 are two virtual pieces of the same type), if a selection operation, which is a click/tap operation, for the virtual piece A1, the virtual piece A1 serves as the first virtual piece, and quantity information of the first virtual piece is displayed.

The quantity information includes a total quantity of first virtual pieces redeemed by the host account and the opponent account.

Exemplarily, the first virtual piece indicates a piece type of the selected virtual piece, the piece pool includes the first virtual piece, and on the match interface, a total quantity of first virtual pieces that can be obtained by the host account and the opponent account through exchange from the piece pool is a preset value. The quantity information of the first virtual piece is configured for describing a quantity of selected virtual pieces that are virtual pieces of the same piece type. For example, the first virtual piece is the virtual piece A1, and a piece type of the virtual piece A1 is Type A, the quantity information displayed based on the selection operation is configured for describing a total quantity of virtual pieces of Type A that are redeemed by the host account and the opponent account. For example, if a virtual piece of Type A that is redeemed by the host account is the virtual piece A1, and a virtual piece of Type A that is redeemed by the opponent account is the virtual piece A2, the quantity information is 2.

In an embodiment, an example in which the total quantity of first virtual pieces redeemed by the host account and the opponent account is referred to as match quantity information is used. The quantity information includes match quantity information of the first virtual piece, and the match quantity information does not exceed the preset value of the first virtual pieces in the piece pool.

In some embodiments, the quantity information further includes a first exchange quantity of first virtual pieces redeemed by the host account, and the first exchange quantity may be referred to as host quantity information. To be specific, the quantity information includes the host quantity information in addition to the foregoing match quantity information.

Exemplarily, the match quantity information allows players to quickly understand a total quantity of first virtual pieces held by both sides in a current virtual match, and help the players quickly analyze a subsequent exchange situation of the first virtual piece, whereby match efficiency and match fairness are enhanced, and the player is encouraged to exchange for the first virtual piece. The host quantity information may more intuitively present status of the first virtual piece owned by the player, helps the player plan a future exchange policy, and helps the player perceive an asset value of the first virtual piece, whereby flexibility of the game is improved. Separate display of the match quantity information and the host quantity information enhances display clarity, optimizes the layout of interface display, helps the player rapidly obtain key information, and better meets a game requirement of the player.

In an embodiment, methods for displaying the quantity information of the first virtual piece include, but are not limited to, the following two methods.

1. Persistently display the quantity information of the first virtual piece on the match interface in response to receiving the selection operation for the first virtual piece.

In an embodiment, the quantity information is persistently displayed in a persistent display area of the match interface. The persistent display area is an area configured for persistently displaying the quantity information, and is a preset area on the match interface.

Exemplarily, before the selection operation is performed on the first virtual piece, the persistent display area is not displayed on the match interface, or the preset persistent display area on the match interface is a blank area, or basic piece information, such as piece identifiers, of a plurality of virtual pieces is displayed in the preset persistent display area on the match interface, but the quantity information is not displayed.

Exemplarily, if the selection operation is performed on the first virtual piece, the quantity information related to the first virtual piece is persistently displayed in the persistent display area. The persistent display process not only enhances a user experience of a player in a case of interface display, but also allows a developer to flexibly arrange a position and a style of the persistent display area, to enhance hierarchy and clarity of interface display. In addition, the quantity information may be further rendered in the persistent display area in a targeted manner based on the persistent display area, whereby data rendering pressure is reduced, data rendering efficiency is optimized, information rendered in the persistent display area can be quickly updated when the quantity information is updated, and information timeliness is maintained.

In an embodiment, a trigger operation for a quantity display control on the match interface is received. The trigger operation is configured for controlling a virtual piece to be in a candidate state.

Exemplarily, the quantity display control is a control configured for triggering enabling of a selected function, and the selected function is a function for receiving a selection operation. A selection operation may be performed on a plurality of virtual pieces on the match interface based on the trigger operation, that is, the plurality of virtual pieces is controlled to be in the candidate state, to receive the selection operation subsequently.

Exemplarily, the candidate state is a selectable state. When a virtual piece is in the candidate state, it indicates that the virtual piece can receive a subsequent selection operation to display the quantity information. In an embodiment, before the quantity display control receives the trigger operation, the plurality of virtual pieces on the match interface is in an ordinary state. For example, the plurality of virtual pieces is in a static state. After the quantity display control receives the trigger operation, status of the plurality of virtual pieces on the match interface is switched from the ordinary state to the candidate state. For example, the status of the plurality of virtual pieces is switched from the static state to a vibrating state. The candidate state can better instruct the player to perform the selection operation on the plurality of virtual pieces.

In an embodiment, in response to receiving the selection operation for the first virtual piece, the quantity information of the first virtual piece is persistently displayed in a control area corresponding to the quantity display control.

The control area corresponding to the quantity display control is one exemplary persistent display area. In an embodiment, the quantity display control is a control occupying a relatively large area, the area occupied by the quantity display control is taken as the control area based on the selection operation, and quantity information is persistently displayed in the control area. Alternatively, the quantity display control is a control occupying a relatively small area. A preset area around the quantity display control is taken as the control area based on the selection operation, and the quantity information and the like are persistently displayed in the control area.

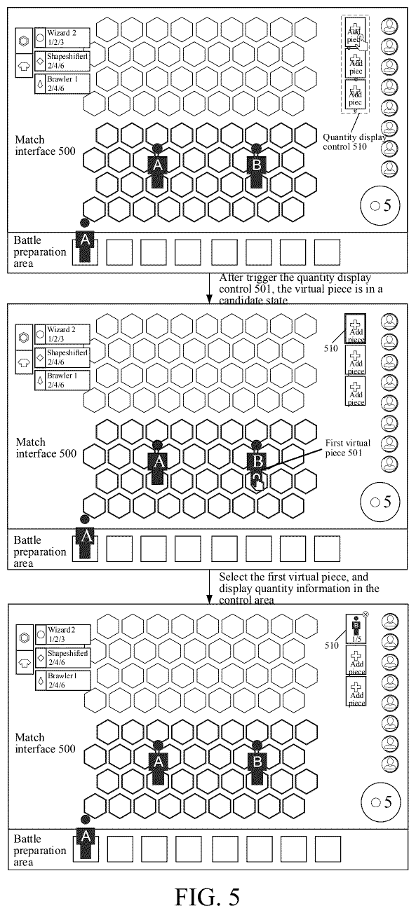

Exemplarily, as shown in FIG. 5, a match interface 500 includes at least one quantity display control 510, the quantity display control 510 corresponds to a control area, and the control area is configured for persistently displaying the quantity information of the first virtual piece.

After the quantity display control 510 is triggered, a first virtual piece 501 on the match interface 500 is selected, and quantity information of the first virtual piece 501 is persistently displayed in the control area corresponding to the quantity display control 510.

The quantity information is “1/5”, which indicates that host quantity information is 1, and match quantity information is 5. To be specific, a quantity of first virtual pieces 501 redeemed by the host account from the piece pool is 1, and a total quantity of first virtual pieces 501 redeemed by the host account and the opponent account from the piece pool is 5.

In an embodiment, an example in which the selection operation for the first virtual piece is a long-press operation is used. The long-press operation for the first virtual piece is received, and duration of the long-press operation meets a preset duration requirement. The quantity information of the first virtual piece is displayed in the persistent display area on the match interface in response to the long-press operation.

Exemplarily, if the duration of the long-press operation reaches one second, it is considered that the selection operation is received, and the quantity information of the first virtual piece is displayed in the persistent display area.

In an embodiment, an example in which the selection operation for the first virtual piece is a copy-and-drag operation is used. The copy-and-drag operation for the first virtual piece is received, and the copy-and-drag operation is configured for copying the first virtual piece, and dragging a copied piece of the first virtual piece to the persistent display area on the match interface. The copied piece is dropped in the persistent display area, and the quantity information of the first virtual piece is displayed in the persistent display area.

In an embodiment, an example in which the selection operation for the first virtual piece is continuous trigger operations is used. The continuous trigger operations for the first virtual piece are received, and a quantity of continuous trigger operations meets a quantity requirement within preset duration. The quantity information of the first virtual piece is displayed in the persistent display area on the match interface in response to the continuous trigger operations.

Exemplarily, if the first virtual piece is continuously triggered twice within one second, the quantity information of the first virtual pieces is displayed in the persistent display area.

In an embodiment, an example in which the selection operation for the first virtual piece is a combination of a trigger operation and a slide operation is used. The trigger operation and the slide operation for the first virtual piece are received, the slide operation is connected to the trigger operation, and a slide direction of the slide operation is a preset direction. The quantity information of the first virtual piece is displayed in the persistent display area on the match interface in response to a slide distance of the slide operation in the preset direction reaching a preset distance.

Exemplarily, the first virtual piece is held after being triggered, is slid in a first direction, and is released when the slide distance of the slide operation in the first direction reaches three centimeters, and the quantity information of the first virtual pieces is displayed in the persistent display area.

The process of performing the selection operation on the first virtual piece in the candidate state based on the trigger operation for the quantity display control is described above. The process of sequentially performing the trigger operation and the selection operation can avoid the problem of mis-trigger of the operation, increase the accuracy of selection of the first virtual piece, enhance the sense of control authenticity of the player during the operation process, enable the player to better adapt to the game process through a multi-operation prompt process, reduce resource consumption caused by mis-trigger, reduce the problem of excessive resource consumption based on one step, and enhance operation accuracy and operation safety.

In some embodiments, text prompt information of the first virtual piece is displayed in response to receiving a text trigger operation for the control area. The text prompt information is configured for describing the quantity information in a text form.

In an embodiment, the text trigger operation includes at least one of a plurality of forms such as a click/tap operation, a long-press operation, a slide operation, a drag operation, and a voice operation. For example, for the selected first virtual piece, the control area configured for persistently displaying the quantity information of the first virtual piece may be triggered, to describe the quantity information in a more detailed text form.

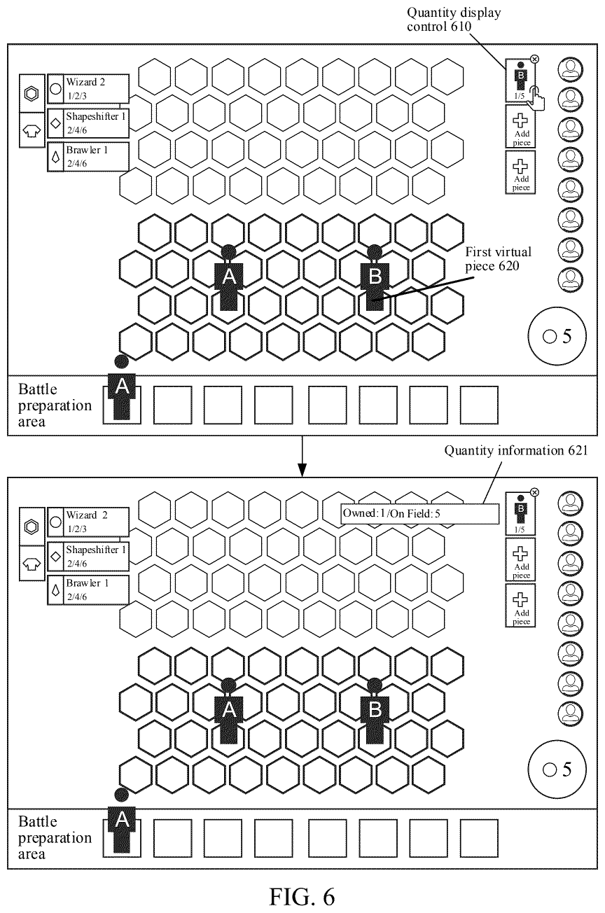

Exemplarily, as shown in FIG. 6, a control area of a quantity display control 610 is configured for displaying quantity information 621 of a first virtual piece 620. After the control area corresponding to the quantity display control 610 is triggered, text prompt information described in a text form is displayed as the quantity information 621:“Owned: 1/On Field: 5”. To be specific, a quantity of first virtual pieces 620 by the host account obtained through exchange/redemption from the piece pool is 1, and a total quantity of first virtual pieces 620 obtained by the host account and the opponent account through exchange from the piece pool is 5.

The process of describing the quantity information in the text form based on the text trigger operation is described above. From the perspective of interface display, presentation of the quantity information in the text form allows the player to more intuitively understand ownership status of the first virtual piece, enhances information obtaining efficiency, and reduces the problem of visual confusion. From the perspective of the technology, switching display of the quantity information in the text form and the simplified quantity information enhances flexibility of data display, whereby a novice player can implement more efficient operations based on the quantity information in the text form, the problem of invalid exchange or mis-exchange for virtual pieces is reduced, and interaction efficiency is enhanced.

In some embodiments, to avoid blockage of excessive quantity display controls for a screen of the virtual match conducted between the virtual pieces, a quantity of quantity display controls configured for persistently displaying quantity information of virtual pieces is typically a preset quantity. In addition, according to an actual situation of each virtual match, the type of the virtual piece having a requirement for persistently displaying quantity information varies.

Exemplarily, a first match is conducted between the host account and a first opponent account, and a second match is conducted between the host account and a second opponent account. A virtual piece that is frequently used in the first match is a virtual piece A, and a virtual piece that is frequently used in the second match is a virtual piece B. In this case, in the first match, the player may select the virtual piece A, to display quantity information of the virtual piece A in a persistent display manner; and in the second game battle, the player may select the virtual piece B, to display quantity information of the virtual piece B in a persistent display manner. The player can select any virtual piece, and use the quantity display control to persistently display quantity information of the virtual piece.

In some embodiments, if the type of the virtual piece needs to be changed, the virtual piece of which the quantity information is displayed can be deselected. In this case, the quantity information displayed in the quantity display control is no longer displayed, and the player may reselect another virtual piece to display corresponding quantity information.

For example, when all quantity display controls are employed to display quantity information of virtual pieces (including virtual pieces A, B, and C), if the player expects one quantity display control to display quantity information of a virtual piece D, the player may deselect any one of the virtual pieces A, B, and C, and reselect the virtual piece D.

In some embodiments, in response to receiving a deselection operation for the first virtual piece, display of the quantity information of the first virtual piece is canceled in the control area corresponding to the quantity display control.

Exemplarily, the deselection operation is an operation configured for canceling display of the quantity information, and the deselection operation includes a cancellation trigger operation (such as a long-press operation or a slide operation) for the first virtual piece; or the deselection operation includes a trigger operation for a deselection control corresponding to the first virtual piece, or the like. An operation form of the deselection operation is not limited herein.

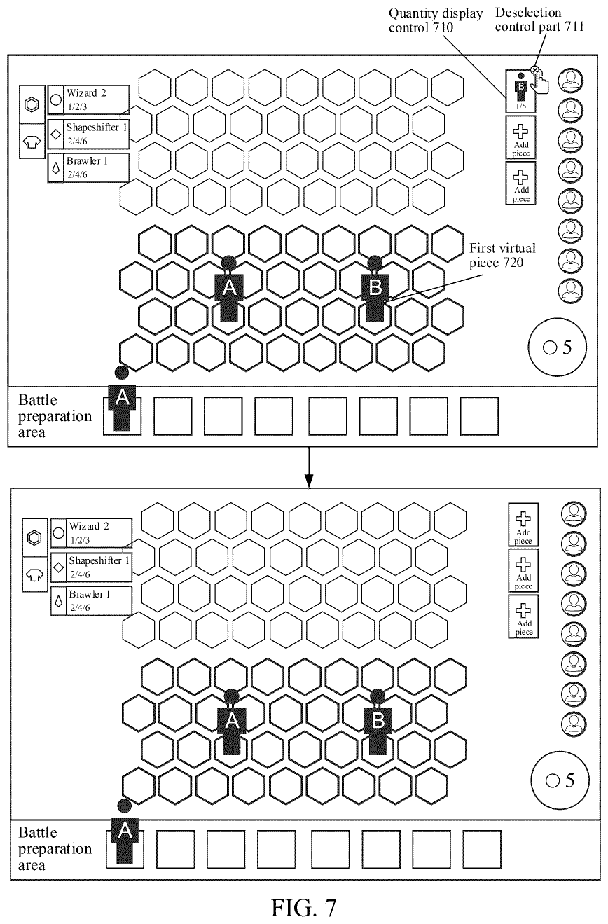

Exemplarily, as shown in FIG. 7, quantity information of a first virtual piece 720 is displayed in a quantity display control 710, and the quantity display control 710 further includes a deselection control part 711. In response to receiving an operation for the deselection control part 711, display of the quantity information of the first virtual piece 720 is canceled in a control area corresponding to the quantity display control 710.

The process of canceling display of the quantity information based on the deselection operation is described above. From the perspective of interface display, setting of the deselection operation enhances display simplicity of the match interface, whereby the player can focus on a current game. In addition, the player can select and control displayed information in a self-defined manner, whereby more control rights are granted to the player to improve a game experience of the player. From the perspective of the technology, the process of canceling display of the quantity information avoids unnecessary data rendering processing while ensuring information display flexibility, whereby a data rendering resource is saved, and the efficiency of processing a game request with higher timeliness is enhanced.

2. Display, in response to receiving the selection operation for the first virtual piece, a piece information display area corresponding to the first virtual piece, the piece information display area including the quantity information of the first virtual piece.

In addition to the foregoing persistent display manner, the method for displaying the quantity information may further includes: the piece information display area including the quantity information of the first virtual piece is displayed in the process of directly selecting the first virtual piece. The quantity information of the first virtual piece is displayed each time the selection operation is received.

In an embodiment, in addition to the quantity information, the piece information display area of the first virtual piece further includes at least one of the following piece information:
(1) a name of the first virtual piece, such as a piece A;
(2) an image of the first virtual piece, for example, if the first virtual piece is a virtual person, the image includes an appearance image of the virtual person;
(3) a type of an action that is performed by the first virtual piece engaging in virtual game battle, such as jumping, shooting, flying, and attacking.
(4) a type of virtual equipment equipped by the first virtual piece, for example, the first virtual piece is equipped with two types of virtual equipment, which are virtual equipment A and virtual equipment B, respectively, the virtual equipment A can increase a speed of the first virtual piece when the first virtual piece engages in virtual game battle, and the virtual equipment B can increase a defense level of the first virtual piece when the first virtual piece engages in virtual game battle; and
(5) type information of the first virtual piece, such as a piece type of a virtual piece to which the first virtual piece belongs, a level of the first virtual piece, and an interaction relationship between the first virtual piece and another virtual piece (such as the first virtual piece and a second virtual piece have a bonding relationship, and the bonding relationship refers to a situation where game battle levels of the first virtual piece and the second virtual piece can be increased when both the first virtual piece and the second virtual piece engage in virtual game battle).

The quantity information of the first virtual pieces includes the match quantity information (namely, the total quantity of first virtual pieces obtained by the host account and the opponent account through exchange from the piece pool), and may further include the host quantity information (namely, the quantity of first virtual pieces obtained by the host account through exchange from the piece pool).

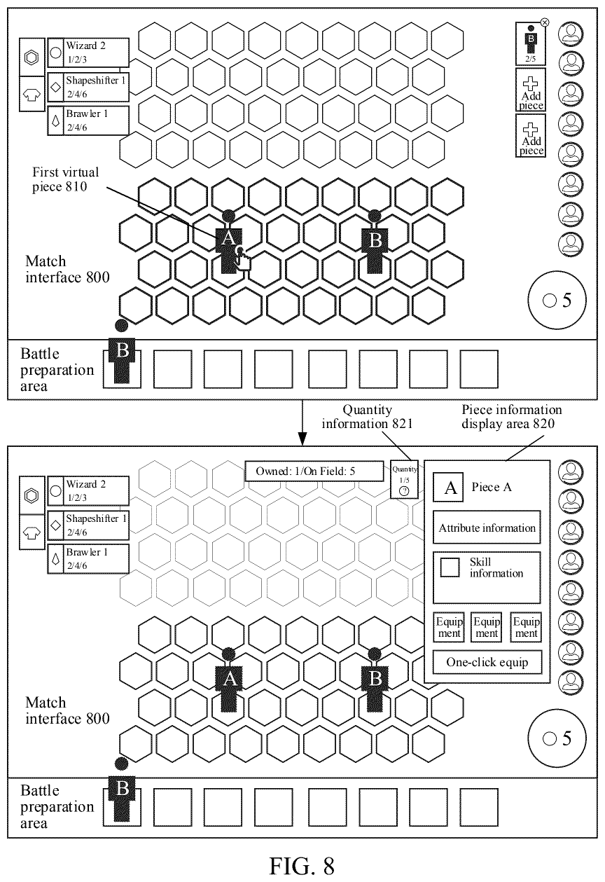

Exemplarily, as shown in FIG. 8, a match interface 800 includes a plurality of virtual pieces. After a first virtual piece 810 is selected, a piece information display area 820 corresponding to the first virtual piece 810 is displayed, and the piece information display area 820 includes piece information of the first virtual piece 810.

The piece information includes quantity information 821 of the first virtual piece 810, which is “1/5”.

In some embodiments, the quantity information 821 corresponds to an information display control, and more detailed quantity information 821 can be displayed after the information display control is triggered. As shown in FIG. 8, the quantity information 821 is “Owned: 1/On Field: 5”.

The process of displaying the piece information display area including the quantity information based on the selection operation is described above. From the perspective of interface display, the piece information display area allows the player to more comprehensively understand the piece information of the virtual piece, and provides more interaction possibilities for the player during the game, and enhances interactivity of the interface and operation accuracy. In addition, from the perspective of the technology, display of a plurality of pieces of piece information based on one selection operation ensures high data transmission efficiency, avoids the problem of inefficiency of separately obtaining piece information based on a plurality of information requests, and facilitates updating the piece information in real time and accurately.

Operation 330 : Update and display, in response to an exchange event of the host account or the opponent account for the first virtual piece, the quantity information corresponding to the first virtual piece.

In an embodiment, an example in which an exchange process is implemented through the piece pool is taken, and the exchange event includes: (1) an account exchanges for a virtual piece from the piece pool; (2) the piece pool reclaims a virtual piece of an account; and (3) player accounts exchange virtual pieces obtained through exchange. For example, the host account uses a virtual piece A to exchange with the opponent account, to obtain a virtual piece B provided by the opponent account.

In an embodiment, when the quantity information of the first virtual piece is displayed in the persistent display area on the match interface, if the host account or the opponent account has the exchange event for the first virtual piece, a change process of the quantity information is displayed in the persistent display area in real time.

Exemplarily, at 22:20:00, the quantity information of the first virtual pieces in the persistent display area is “1/5”. To be specific, the quantity of first virtual pieces redeemed by the host account is 1, the total quantity of first virtual pieces redeemed by the host account and the opponent account is 5, and the piece pool still includes five first virtual pieces that have not been exchanged for.

At 22:30:00, an exchange event “The host account exchanges for two first virtual pieces from the piece pool” occurs, and no exchange event occurs between 22:20:00 and 22:30:00. In this case, the quantity of first virtual pieces redeemed by the host account is equal to 1+2=3, the total quantity of first virtual pieces redeemed by the host account and the opponent account is equal to 5+2=7, and the piece pool still includes three first virtual pieces that have not been exchanged for. The displayed quantity information of the first virtual piece is updated to “3/7”.

At 22:35:00, an exchange event “The opponent account exchanges for one first virtual piece from the piece pool” occurs, and no exchange event occurs between 22:30:00 and 22:35:00. In this case, the quantity of first virtual pieces redeemed by the host account is 3, the total quantity of first virtual pieces redeemed by the host account and the opponent account is equal to 7+1=8, and the piece pool still includes two first virtual pieces that have not been exchanged for. The displayed quantity information of the first virtual piece is updated to “3/8”.

At 22:45:00, an exchange event “The piece pool reclaims two first virtual pieces of the opponent account” occurs, and no exchange event occurs between 22:35:00 and 22:45:00. In this case, the quantity of first virtual pieces redeemed by the host account is 3, the total quantity of first virtual pieces redeemed by the host account and the opponent account is equal to 8-2=6, and the piece pool still includes four first virtual pieces that have not been exchanged for. The displayed quantity information of the first virtual piece is updated to “3/6”.

In an embodiment, when the quantity information of the first virtual piece is displayed in the piece information display area corresponding to the first virtual piece on the match interface, if the host account or the opponent account has the exchange event for the first virtual piece, the quantity information is updated and displayed each time the first virtual piece is triggered.

Exemplarily, at 22:20:00, a selection operation for the first virtual piece is received, and the quantity information of the first virtual piece is displayed in the piece information display area, which is “1/5”. To be specific, the quantity of first virtual pieces redeemed by the host account is 1, the total quantity of first virtual pieces redeemed by the host account and the opponent account is 5, and the piece pool still includes five first virtual pieces that have not been exchanged for.

At 22:36:00, a selection operation for the first virtual piece is received again, and two exchange events for the first virtual piece occur between 22:20:00 and 22:36:00, which are respectively as follows:
1. At 22:30:00, an exchange event “The host account exchanges for two first virtual pieces from the piece pool”, and in this case, the quantity of first virtual pieces redeemed by the host account is equal to 1+2=3, the total quantity of first virtual pieces redeemed by the host account and the opponent account is equal to 5+2=7, and the piece pool still includes three first virtual pieces that have not been exchanged for.
2. At 22:35:00, an exchange event “The opponent account exchanges for one first virtual piece from the piece pool”, and in this case, the quantity of first virtual pieces redeemed by the host account is 3, the total quantity of first virtual pieces redeemed by the host account and the opponent account is equal to 7+1=8, and the piece pool still includes two first virtual pieces that have not been exchanged for.

Therefore, when the selection operation for the first virtual piece is received at 22:36:00, the displayed quantity information of the first virtual piece is updated to “3/8”.

A server records a quantity change process of each virtual piece in real time, and when receiving the selection operation for the first virtual piece, and transmits the quantity information of the first virtual piece to a terminal according to the virtual piece information indicated by the selection operation, and the terminal displays the quantity information of the first virtual piece in a corresponding display area.

In an embodiment, for the persistently displayed quantity information of the virtual pieces, the server transmits the quantity information of the virtual piece to the terminal in real time for updating and displaying.

In an embodiment, for the quantity information of the virtual piece that is displayed in the piece information display area, only when receiving the selection operation for the virtual piece, the server transmits updated quantity information to the terminal for updating once. To be specific, quantity information of the first virtual piece at a current moment is displayed each time the selection operation is received.

In conclusion, on the match interface of the board game, the quantity information of the virtual piece can be displayed based on the selection operation for the virtual piece without the need of memorizing by a player. The quantity information includes the total quantity of virtual pieces redeemed by the host account and the opponent account on the match interface. The quantity information not only allows the player to understand strength of both sides in a current match timely, but also can reflect a quantity of remaining virtual pieces that can be obtained through exchange, whereby more detailed prompt information is provided for the player to control the virtual piece to engage in virtual game battle. When the exchange event for the virtual piece occurs, the quantity information of the virtual piece is updated in real time, whereby the change in the quantity of virtual pieces can be prompted timely. This not only significantly enhances human-computer interaction efficiency of the player, but also can enhance efficiency and accuracy of a statistical result of the quantity information.

According to the method provided in this embodiment, the quantity information further includes the host quantity information, which can prompt the quantity of first virtual pieces redeemed by the host account, and assist the player in arranging the virtual pieces in the game battle preparation stage.

According to the method provided in this embodiment, by triggering the quantity display control and then selecting the first virtual piece of which the quantity information needs to be determined, the quantity information of the first virtual piece can be persistently displayed in the corresponding control area.

According to the method provided in this embodiment, by persistently displaying the quantity information of the first virtual piece on the match interface, the player can observe a change in the quantity information at any time.

According to the method provided in this embodiment, when the quantity information in the persistent display area needs to be deleted, display of the quantity information of the virtual piece can be canceled based on the deselection operation, and when quantity information of another virtual piece needs to be persistently displayed, the another virtual piece is reselected.

According to the method provided in this embodiment, by directly selecting the first virtual piece, the quantity information is displayed in the piece information display area, whereby the player can trigger the first virtual piece at any time to view the quantity information immediately, and the screen of the interface is not blocked for a long time.

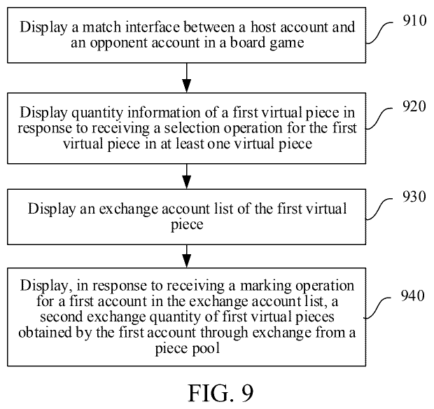

FIG. 9 is a flowchart of an information display method according to another exemplary embodiment of the present disclosure. The method includes the following operations:

Operation 910: Display a match interface between a host account and an opponent account in a board game.

The match interface includes a plurality of virtual pieces. A host virtual piece is a virtual piece redeemed by the host account, and the host virtual piece is configured to engage in virtual game battle against an opponent virtual piece redeemed by the opponent account. The opponent account is an account that participates in an auto battler match with the host account.

Operation 920: Display quantity information of a first virtual piece in response to receiving a selection operation for the first virtual piece in the plurality of virtual pieces.

The match interface includes a game battle area and a game battle preparation area. The game battle area is an area where an auto battler match is conducted between the opponent account and the host account, and the game battle preparation area is an area where the opponent account and the host account make preparations before the auto battler match starts. Virtual pieces may exist in both the game battle area and the game battle preparation area. In an embodiment, the virtual pieces in the game battle area and the game battle preparation area are all redeemed by the host account or the opponent account from a piece pool. The piece pool includes a plurality of types of virtual pieces, and a quantity of each type of virtual piece is a preset value.

Sources of the first virtual piece include, but are not limited to the following:

(1) A virtual piece is selected from the game battle preparation area and the game battle area as the first virtual piece.

The quantity information of the first virtual piece is displayed in response to receiving a selection operation for the first virtual piece in the game battle preparation area or the game battle area.

(2) A virtual piece is selected from a preset piece list as the first virtual piece.

In some embodiments, in addition to virtual pieces included in an area preset by an application program on the match interface, a player can customize a piece list according to a game battle requirement.

The quantity information of the first virtual piece is displayed in response to receiving a selection operation for the first virtual piece in the preset piece list.

The preset piece list includes at least one of a user-defined piece list and a piece exchange area. A candidate piece in the preset piece list includes at least one of the following: a virtual piece with usage frequency meeting a preset requirement, a virtual piece with exchange frequency meeting a preset requirement, and a user-defined virtual piece.

Exemplarily, the usage frequency is the frequency of using the virtual piece. For example, the usage frequency is a number of times a particular type of virtual piece is used within a preset historical time period; or the usage frequency is a ratio of the number of times the particular type of virtual piece is used within the preset historical time period to a total number of times all virtual pieces are used within the preset historical time period. The preset requirement is a preset frequency threshold. For example, when a number of times a virtual piece A is used reaches a preset number of times, the virtual piece A is taken as a candidate piece.

The exchange frequency is the frequency of exchanging for the virtual piece. For example, the exchange frequency is a number of times a particular type of virtual piece is exchanged for within a preset historical time period; or the exchange frequency is a ratio of the number of times the particular type of virtual piece is exchanged for within the preset historical time period to a total number of times all virtual pieces are exchanged for within the preset historical time period. The preset requirement is a preset exchange frequency range. For example, when a number of times a virtual piece B is exchanged for reaches a preset number of exchange times, the virtual piece B is taken as a candidate piece.

The user-defined virtual piece is a virtual piece set by the player in a user-defined manner. For example, the player obtains a piece preparation material by completing a preset in-game task, and obtains a user-defined virtual piece by refining the piece preparation material. Alternatively, the player implements the process of customizing the virtual piece based on a preset customization function in the board game, for example, implements the process of the customizing the virtual piece by adjusting attribute information, such as a piece appearance, a piece function, and piece attack power, of the virtual piece.

The candidate piece included in the preset piece list may be any type of virtual piece included in the piece pool. To be specific, the preset piece list may include the virtual pieces existing in the game battle area and the game battle preparation area, or may include virtual pieces not existing in the game battle area and the game battle preparation area.

In some embodiments, the piece pool is not displayed on the match interface, and the host account or the opponent account obtains the virtual piece through exchange in the piece exchange area. The piece exchange area includes a plurality of virtual pieces and virtual piece exchange conditions. For example, two virtual resources may be used to exchange for one virtual piece A, and three virtual resources may be used to exchange for one virtual piece B.

If a virtual piece of which quantity information is required to be displayed by the player does not exist in the game battle area and the game battle preparation area, a virtual piece may be selected from the preset piece list to view a change in a quantity of virtual pieces.

In an embodiment, a description is made by using an example in which a virtual piece is selected from the piece exchange area as the first virtual piece.

Exemplarily, the piece pool includes ten types of virtual pieces, and the piece exchange area may include a plurality of types of virtual pieces in the piece pool. The piece exchange area may display five types of virtual pieces each time, and the types of the virtual pieces displayed in the piece exchange area may be changed by performing a refresh operation for the piece exchange area.

Exemplarily, at 22:22:22, a selection operation for the first virtual piece in the piece exchange area is received, and quantity information corresponding to the first virtual piece is displayed. In this case, the quantity information of the first virtual piece is “0/0”, which indicates that the first virtual piece has not been redeemed by the host account and the opponent account.

At 22:22:23, the opponent account has an exchange event “The opponent account exchanges for one first virtual piece from the piece pool” for the first virtual piece, the quantity information is updated to “0/1”, to remind the player that the quantity of first virtual pieces has changed.

Operation 930: Display an exchange account list of the first virtual piece.

In addition to the displayed quantity information corresponding to the first virtual piece owned by the host account, the player can view status of first virtual pieces respectively owned by a plurality of opponent accounts.

When the selection operation for the first virtual piece is received, the displayed quantity information includes by default a quantity of first virtual pieces owned by the host account. Therefore, in some embodiments, after the first virtual piece is selected, the exchange account list of the first virtual piece is displayed at the same time.

The exchange account list includes an account that is in the opponent account and that obtains the first virtual piece through exchange from the piece pool. In other words, the opponent account may include one or more accounts that plays as an opponent as the host account, and the exchange account list includes opponent redemption activity related to the first virtual piece.

In an embodiment, one host account and seven opponent accounts exist on the match interface. The quantity information of the first virtual pieces is “1/5”, which indicates that the host account owns one first virtual piece, and the remaining seven opponent accounts own a total of four first virtual pieces.

In an embodiment, the exchange account list of the first virtual piece includes the following accounts: the host account, a first opponent account, a second opponent account, and a third opponent account.

The host account owns one first virtual piece, the first opponent account owns one first virtual piece, the second opponent account owns one first virtual piece, and the third opponent account owns two first virtual pieces.

In an embodiment, the opponent account in the exchange account list is an account that owns the first virtual piece, and other opponent accounts that do not own the first virtual piece are not displayed in the exchange account list. Alternatively, an opponent account that owns the first virtual piece in the exchange account list is in a first state, and other opponent accounts that do not own the first virtual piece are in a second state. The first state is different from the second state. For example, an account avatar of the opponent account in the first state is in a highlighted form, and an account avatar of the opponent account in the second state is in a grayscale form. This is not limited herein.

Operation 940: Display, in response to receiving a marking operation for a first account in the exchange account list, a second exchange quantity of first virtual pieces redeemed by the first account.

In an embodiment, the first account is a first opponent account in at least one opponent account in the exchange account list, the marking operation for the first opponent account is received, and the second exchange quantity of first virtual pieces obtained by the first opponent account through exchange from the piece pool is displayed, which is 1.

Exemplarily, the marking operation is an operation configured for selecting the first account from the at least one opponent account. The selected first account is taken as an opponent account that needs to be viewed based on the marking operation, to understand status of the first virtual piece owned by the first account in more detail.

In an embodiment, the marking operation includes at least one of a click/tap operation, a long-press operation, a slide operation, a drag operation, and a voice operation; For example, after the exchange account list is displayed, the marking operation, namely, a click/tap operation, for the first account in the exchange account list is received, the second exchange quantity of first virtual pieces redeemed by the first account is obtained from a server, and the second exchange quantity is displayed.

In an embodiment, based on the two methods for displaying the quantity information of the first virtual piece, there are also two methods for displaying the quantity information of the first virtual pieces belonging to different accounts.

1. Persistently display quantity information.

A trigger operation for a quantity display control is received, to cause all virtual pieces on the match interface (including the virtual pieces in the game battle area, the game battle preparation area, and the preset piece list) to be in a candidate state. After the first virtual piece is selected, the exchange account list of the first virtual piece is displayed, the first account in the exchange account list is marked, and the quantity information of the first virtual piece owned by the first account is persistently displayed in a control area corresponding to a quantity display area.

2. Display the quantity information in a piece information display area.

The first virtual piece is directly selected. If the first virtual piece is a virtual piece existing in the game battle area and the game battle preparation area, the quantity information of the first virtual piece is directly displayed according to status of an account to which the first virtual piece belongs.

For example, two first virtual pieces exist in the game battle area, which respectively belong to the host account and the first opponent account. If the first virtual piece belonging to the host account is selected, quantity information displayed in the piece information display area is “the quantity of first virtual pieces owned by the host account/the total quantity of first virtual pieces owned by the host account and the opponent account”. If the first virtual piece belonging to the first opponent account is selected, quantity information displayed in the piece information display area is “the quantity of first virtual pieces owned by the first opponent account/the total quantity of first virtual pieces owned by the host account and the opponent account”.

The exchange account list is displayed while the foregoing quantity information is displayed. If the first virtual piece owned by the first opponent account is selected, and it is expected to display the quantity information of the first virtual piece belonging to the host account, the host account in the exchange account list is marked, and the quantity information of the first virtual piece belonging to the host account is displayed in the piece information display area.

If the first virtual piece is a virtual piece in the preset piece list, and the first virtual piece does not exist in the game battle area and the game battle preparation area, the quantity information of the first virtual piece in the piece information display area is “0/0”. If an exchange event occurs after the first virtual piece is selected, an account that first exchanges for the first virtual piece is taken as the first account by default, and the quantity information of the first virtual piece correspondingly owned by the first account is displayed.

In some embodiments, in addition to the foregoing several methods for viewing the quantity information of the first virtual piece possessed by the opponent account, the first virtual piece owned by the opponent account may be directly selected, to view the quantity information of the first virtual piece owned by the opponent account. Alternatively, the first virtual piece owned by the host account is selected, to switch a viewpoint from a viewpoint of the host account in the match to a viewpoint of the opponent account in the match. After the viewpoint is switched, the quantity information of the first virtual piece is automatically switched to the quantity information of the first virtual piece owned by the opponent account. Alternatively, after the viewpoint is switched, the first virtual piece is directly selected from the game battle area of the opponent account, and the quantity information of the first virtual piece is displayed.

In an embodiment, the match interface includes a total of eight accounts, which are one host account and seven opponent accounts. Every two accounts are randomly matched into the same auto battler match, and four auto battler matches may be simultaneously conducted within the same time period.

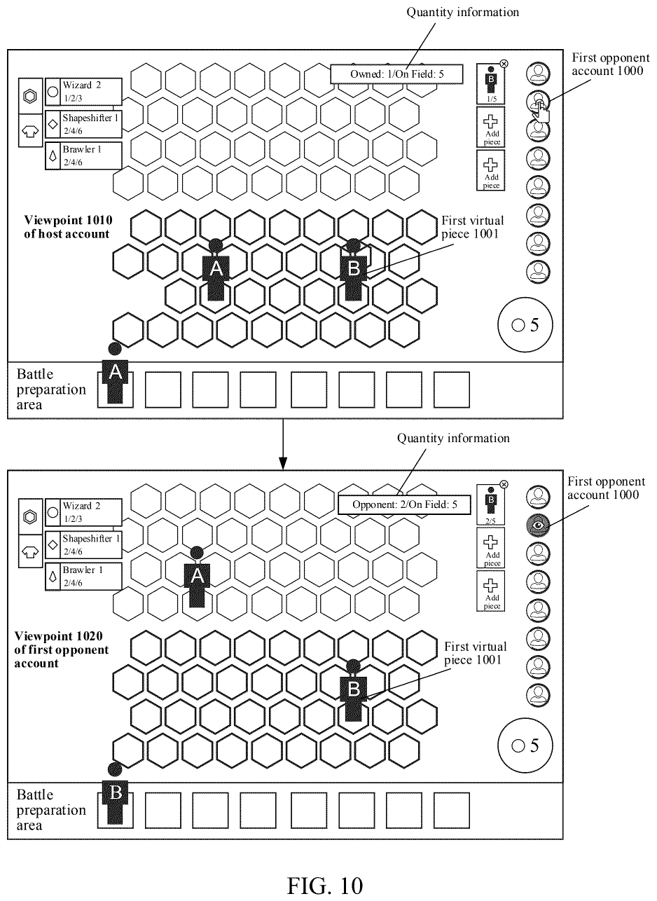

Exemplarily, as shown in FIG. 10, an auto battler match is conducted between a host account and a first opponent account 1000, a first virtual piece 1001 belonging to the host account is selected, and displayed quantity information is “Owned: 1/On Field: 5”, which indicates that a quantity of first virtual pieces 1001 redeemed by the host account is 1, and a total quantity of first virtual pieces 1001 redeemed by the host account and seven opponent accounts is 5.

An account identifier of the first opponent account 1000 is selected, to switch a viewpoint from a viewpoint 1010 of the host account to a viewpoint 1020 of the first opponent account. In this case, displayed quantity information of the first virtual piece 1001 is “Opponent: 2/On Field: 5”, which indicates that a quantity of first virtual pieces 1001 redeemed by the first opponent account 1000 is 2, and the total quantity of first virtual pieces 1001 redeemed by the host account and the seven opponent accounts is 5.

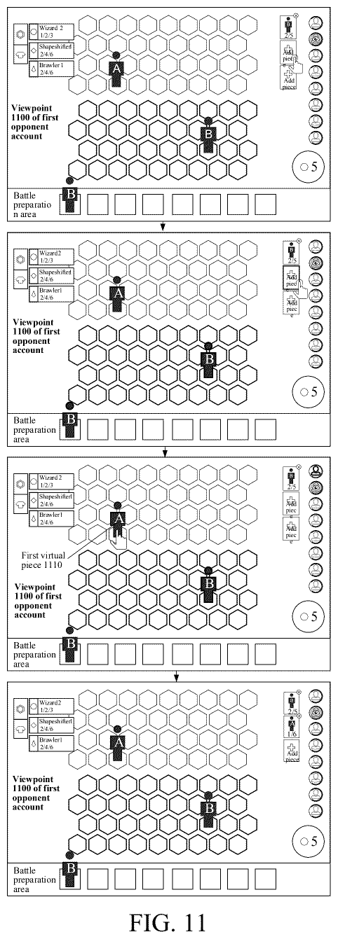

Exemplarily, as shown in FIG. 11, when a viewpoint is switched to a viewpoint 1100 of a first opponent account, a first virtual piece 1110 owned by the first opponent account is selected, and quantity information of the first virtual piece 1110 is displayed in a persistent display manner.

In conclusion, the quantity information not only allows the player to understand strength of both sides in a current match timely, but also can reflect a quantity of remaining virtual pieces that can be obtained through exchange, whereby more detailed prompt information is provided for the player to control the virtual piece to engage in virtual game battle. When the exchange event for the virtual piece occurs, the quantity information of the virtual piece is updated in real time, whereby the change in the quantity of virtual pieces can be prompted timely. This not only significantly enhances human-computer interaction efficiency of the player, but also can enhance efficiency and accuracy of a statistical result of the quantity information.

According to the method provided in this embodiment, after the first virtual piece is selected, the exchange account list of the first virtual piece is displayed, to present the opponent account that owns the first virtual piece more intuitively, whereby an association between the opponent account and the first virtual piece can be strengthened. In addition, if an account in the exchange account list is marked, a specific quantity of first virtual pieces owned by the account can be directly obtained, whereby precision of understanding the quantity of pieces owned by the opponent account is further strengthened, efficiency and precision of understanding the virtual piece are enhanced, the player can arrange the virtual pieces in a more targeted manner, game battle efficiency is enhanced, and an invalid data handling amount is reduced.

According to the method provided in this embodiment, the selection operation may be performed on the virtual piece existing in the preparation area and the game battle area, to display corresponding quantity information, whereby a display range of the quantity information is increased, a targeted piece arrangement can be planned in the preparation stage, and the piece arrangement can be flexibly adjusted in the game battle stage, and accuracy and efficiency of the piece arrangement are enhanced. In addition, the virtual piece that does not exist in the preparation area and the game battle area may be marked based on the preset piece list, to display the change in the quantity of first virtual pieces, whereby flexibility of piece marking is enhanced, a subsequent change in the quantity of pieces can be known timely, and deployment flexibility of game battle strategies is enhanced.

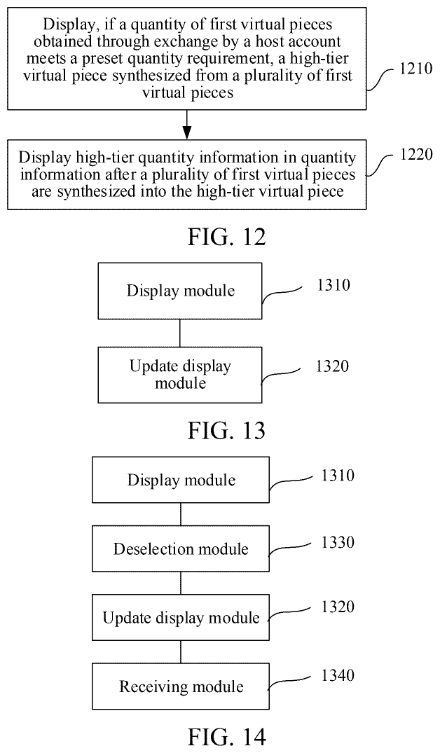

The quantity of virtual pieces in the piece pool has a maximum value. To be specific, a total quantity of each type of virtual piece that can be redeemed by the host account and the opponent account is limited. In some embodiments, when a quantity of virtual pieces of the same type that owned by the player reaches a particular value, an upgrade operation may be performed on these virtual pieces. To be specific, the plurality of virtual pieces of the same type are synthesized into a high-tier virtual piece (also referred to as an updated virtual piece hereinafter). The high-tier virtual piece has different piece information compared with a non-synthesized virtual piece. Use of the high-tier virtual piece can increase the probability of winning some auto battler matches. FIG. 12 is a flowchart of a method for displaying quantity information of a high-tier virtual piece. The method includes the following operations:

Operation 1210: Display, if a quantity of first virtual pieces redeemed by a host account meets a preset quantity requirement, a high-tier virtual piece synthesized from a plurality of first virtual pieces.

Attribute information of the high-tier virtual piece is different from attribute information of the first virtual piece. The attribute information is configured for describing piece game battle status of the virtual piece, and the attribute information includes at least one of a plurality of pieces of information such as a piece level, a piece function, a piece appearance, piece attack power, and piece defense power. Different attribute information indicates that there is a difference between the attribute information of the high-tier virtual piece and the attribute information of the first virtual piece, for example, piece levels are different, or piece levels and piece attack power are different. This is not limited herein. For example, a level of the first virtual piece is level 1, and a level of a high-tier virtual piece synthesized from three first virtual pieces is level 2. The game battle level of the first virtual piece is lower than the game battle level of the high-tier virtual piece. For example, a movement speed of the first virtual piece is lower than a speed of the high-tier virtual piece.

In an embodiment, when there are three first virtual pieces, the three first virtual pieces may be synthesized once, to obtain one high-tier virtual piece. The virtual pieces included in the piece pool are non-synthesized virtual pieces, and an exchangeable quantity of each type of virtual pieces is limited.

A number of times high-tier virtual pieces are synthesized may be any value. For example, three first virtual pieces are synthesized into one high-tier virtual piece, and nine first virtual pieces are synthesized into three high-tier virtual pieces (first high-tier virtual pieces for short), and the three high-tier virtual pieces can be synthesized into a higher-tier virtual piece (a second high-tier virtual piece for short).

Exemplarily, if a maximum exchange quantity of first virtual pieces in the piece pool is 10, the host account already owns two first virtual pieces, and a total quantity of first virtual pieces redeemed by opponent accounts is 7, which indicates that the piece pool still includes one first virtual piece. In this case, the host account can exchange for one additional first virtual piece from the piece pool, to obtain a total of 1+2=3 first virtual pieces, which are synthesized into one high-tier virtual piece.

When the plurality of first virtual pieces are synthesized into the high-tier virtual piece, statistical data before synthesis is displayed as the quantity information of the first virtual piece.

Exemplarily, if a maximum exchange quantity of first virtual pieces in the piece pool is 10, the host account already owns eight first virtual pieces, and a total quantity of first virtual pieces redeemed by opponent accounts is 2, which indicates that the piece pool includes zero first virtual piece. In this case, the host account cannot exchange for an additional first virtual piece from the piece pool, the eight first virtual pieces can be synthesized into two high-tier virtual pieces, and two first virtual pieces remain.

Therefore, for a player needs to synthesize a high-tier virtual piece, by selecting the first virtual piece and displaying the quantity information of the first virtual pieces in real time, the player can determine a quantity of remaining first virtual pieces in the piece pool timely, and further determine whether to exchange for more first virtual pieces to synthesize high-tier virtual pieces, whereby occurrence of a situation in which the player repeatedly exchange for the first virtual pieces but cannot synthesize high-tier virtual pieces is avoided, comprehensiveness of information prompt is enhanced, human-computer interaction efficiency is enhanced, and invalid data processing is avoided.

Operation 1220: Display high-tier quantity information in quantity information after a plurality of first virtual pieces are synthesized into the high-tier virtual piece.

The high-tier quantity information is configured for indicating a total quantity of high-tier virtual pieces synthesized by the host account and the opponent account.

Exemplarily, the host account synthesizes one high-tier virtual piece from three first virtual pieces, and the opponent accounts have not synthesized a high-tier virtual piece. In this case, the quantity information corresponding to the first virtual piece is “1/3/5”, which indicates that a total quantity of high-tier virtual pieces synthesized by the host account and the opponent account is 1; the quantity of first virtual pieces obtained by the host account through exchange from the piece pool is 3; and the total quantity of first virtual pieces obtained by the host account and the opponent account through exchange from the piece pool is 5.

In some embodiments, an exchange lock operation for the first virtual piece is received in response to that an account level of the host account meets a preset level requirement, the exchange lock operation being configured for locking the first virtual piece in the piece pool, and the locked first virtual piece in the piece pool being incapable of being redeemed by either the host account or the opponent account; and locked quantity information is displayed in the quantity information, the locked quantity information being configured for indicating a total quantity of first virtual pieces in the piece pool that are locked by the host account and the opponent account.

Exemplarily, the preset level requirement is that an account level reaches level 400 (a range is from level 1 to level 500, and a larger number indicates a higher level). When the account level of the host account reaches level 400, the host account may select a preset quantity (such as one) of first virtual pieces, and perform exchange locking on the selected first virtual pieces, and the locked first virtual pieces are located in the piece pool and cannot be obtained through exchange/redemption by any account.

Exemplarily, the quantity information is “1/1/3/5”, which indicates that one first virtual piece in the piece pool is locked and is in an unexchangeable state; a total quantity of high-tier virtual pieces synthesized by the host account and the opponent account is 1; the quantity of first virtual pieces obtained by the host account through exchange from the piece pool is 3; and the total quantity of first virtual pieces obtained by the host account and the opponent account through exchange from the piece pool is 5.

In conclusion, the quantity information not only allows the player to understand strength of both sides in a current match timely, but also can reflect a quantity of remaining virtual pieces that can be obtained through exchange, whereby more detailed prompt information is provided for the player to control the virtual piece to engage in virtual game battle. When the exchange event for the virtual piece occurs, the quantity information of the virtual piece is updated in real time, whereby the change in the quantity of virtual pieces can be prompted timely. This not only significantly enhances human-computer interaction efficiency of the player, but also can enhance efficiency and accuracy of a statistical result of the quantity information.

According to the method provided in this embodiment, the preset quantity of first virtual pieces are synthesized into a corresponding high-tier virtual piece, which increases interestingness and a win probability in the auto battler game. In addition, the total quantity of high-tier virtual pieces synthesized by all accounts is displayed in the quantity information, and can serve as prompt information when the player controls the virtual piece to engage in an auto battler match.

According to the method provided in this embodiment, the quantity information of the first virtual piece is still displayed according to the statistical data before the high-tier virtual piece is synthesized, whereby the quantity of remaining virtual pieces in the piece pool that can be obtained through exchange/redemption can be more accurately reflected, errors in match strategy analysis caused by the player abandoning exchange for virtual pieces too early can be prevented, incorrect quantity information display when high-tier virtual pieces cannot be synthesized can be avoided, invalid data loading is avoided while accuracy of information display is ensured, and an invalid data transmission amount and a data rendering amount are reduced.

According to the method provided in this embodiment, exchange locking can be performed on the virtual pieces in the piece pool in response to that the level of the host account meets the preset level requirement, and the locked virtual pieces cannot be redeemed by the opponent account, whereby the host account is encouraged to upgrade the account level as soon as possible, to enhance the control for the first virtual piece, the probability that the opponent account synthesizes the high-tier virtual piece is reduced while the quantity of first virtual pieces obtained by the opponent account is limited, the probability of winning the virtual game battle is increased, the gameplay diversity of the game, game interestingness, and game strategy are enhanced, and a game experience is enhanced.

FIG. 13 is a structural block diagram of an information display apparatus according to an exemplary embodiment of the present disclosure. The apparatus includes the following parts:
a display module 1310, configured to display a match interface between a host account and an opponent account in a board game, the match interface including a plurality of virtual pieces; a host virtual piece being a virtual piece redeemed by the host account, and the host virtual piece being configured to engage in virtual game battle against an opponent virtual piece redeemed by the opponent account,
the display module 1310 being further configured to display quantity information of a first virtual piece in response to receiving a selection operation for the first virtual piece in the plurality of virtual pieces, the quantity information including a total quantity of first virtual pieces redeemed by the host account and the opponent account; and
an update display module 1320, configured to update and display, in response to an exchange event of the host account or the opponent account for the first virtual piece, the quantity information corresponding to the first virtual piece.

In an embodiment, the quantity information further includes a first exchange quantity of first virtual pieces redeemed by the host account.

In an embodiment, the display module 1310 is configured to persistently display the quantity information of the first virtual piece on the match interface in response to receiving the selection operation for the first virtual piece.

In an embodiment, the display module 1310 is further configured to receive a trigger operation for a quantity display control on the match interface, the trigger operation being configured for controlling a virtual piece to be in a candidate state; and persistently display, in response to receiving the selection operation for the first virtual piece, the quantity information of the first virtual piece in a control area corresponding to the quantity display control.

In an embodiment, the display module 1310 is further configured to display text prompt information of the first virtual piece in response to receiving a text trigger operation for the control area, the text prompt information being configured for describing the quantity information in a text form.

In an embodiment, the display module 1310 is further configured to display, in response to receiving the selection operation for the first virtual piece, a piece information display area corresponding to the first virtual piece, the piece information display area including the quantity information of the first virtual piece.

In an embodiment, the display module 1310 is further configured to display an exchange account list of the first virtual piece, the exchange account list including an account that is in the opponent account and that obtains the first virtual piece through exchange; and display, in response to receiving a marking operation for a first account in the exchange account list, a second exchange quantity of first virtual pieces redeemed by the first account.

In an embodiment, the match interface includes a game battle area and a game battle preparation area, the game battle area is an area where an auto battler match is conducted between the opponent account and the host account, and the game battle preparation area is an area where the opponent account and the host account make preparations before the auto battler match starts.

The display module 1310 is further configured to display the quantity information of the first virtual piece in response to receiving a selection operation for the first virtual piece that is in the game battle preparation area or the game battle area and that is in the plurality of virtual pieces; or display the quantity information of the first virtual piece in response to receiving a selection operation for the first virtual piece in a preset piece list, the preset piece list including at least one of a user-defined piece list and a piece exchange area, and a candidate piece in the preset piece list including at least one of the following: a virtual piece with usage frequency meeting a preset requirement, a virtual piece with exchange frequency meeting a preset requirement, or a user-defined virtual piece.

In an embodiment, the display module 1310 is further configured to display, in response to that the quantity of first virtual pieces redeemed by the host account meets a preset quantity requirement, a high-tier virtual piece synthesized from a plurality of first virtual pieces, attribute information of the high-tier virtual piece being different from attribute information of the first virtual piece; and when the plurality of first virtual pieces are synthesized into the high-tier virtual pieces, statistical data before synthesis being displayed as the quantity information of the first virtual pieces.

In an embodiment, the display module 1310 is further configured to display high-tier quantity information in the quantity information after the plurality of first virtual pieces are synthesized into the high-tier virtual piece, the high-tier quantity information being configured for indicating a total quantity of high-tier virtual pieces synthesized by the host account and the opponent account.

In an embodiment, after the display module 1310, as shown in FIG. 14, the apparatus further includes:
a deselection module 1330, configured to cancel, in response to receiving a deselection operation for the first virtual piece, display of the quantity information of the first virtual piece in the control area corresponding to the quantity display control.

In an embodiment, the apparatus further includes:
a receiving module 1340, configured to receive an exchange lock operation for the first virtual piece in response to that an account level of the host account meets a preset level requirement, the exchange lock operation being configured for locking the first virtual piece in a piece pool, and the locked first virtual piece in the piece pool being incapable of being obtained through exchange/redemption by either the host account or the opponent account.

The display module 1310 is further configured to display locked quantity information in the quantity information, the locked quantity information being configured for indicating a total quantity of first virtual pieces in the piece pool that are locked by the host account and the opponent account.

In conclusion, the quantity information not only allows the player to understand strength of both sides in a current match timely, but also can reflect a quantity of remaining virtual pieces that can be obtained through exchange, whereby more detailed prompt information is provided for the player to control the virtual piece to engage in virtual game battle. When the exchange event for the virtual piece occurs, the quantity information of the virtual piece is updated in real time, whereby the change in the quantity of virtual pieces can be prompted timely. This not only significantly enhances human-computer interaction efficiency of the player, but also can enhance efficiency and accuracy of a statistical result of the quantity information.

The information display apparatus provided in the foregoing embodiments is illustrated only with an example of division of the foregoing functional modules. In practical application, the foregoing functions may be assigned to and completed by different functional modules as needed. That is, an internal structure of a device is divided into different functional modules to complete all or some of the functions described above. In addition, the information display apparatus provided in the foregoing embodiments and the information display method provided in the foregoing embodiments belong to the same conception. For the specific implementation process of the information display apparatus, refer to the method embodiments. Details are not described herein again.

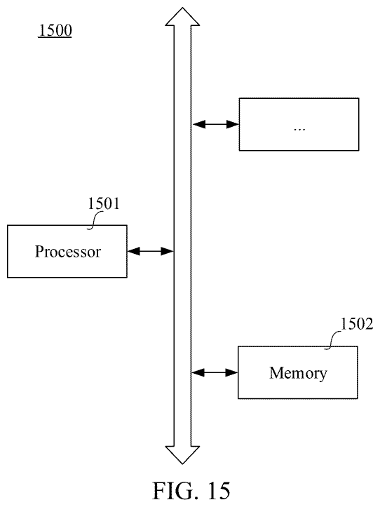

FIG. 15 is a structural block diagram of a computer device 1500 according to an exemplary embodiment of the present disclosure. The computer device 1500 may be a smartphone, a tablet computer, a MP3 player, a MP4 player, a notebook computer, or a desktop computer. The computer device 1500 may further be referred to as another name such as a user device, a portable terminal, a laptop terminal, or a desktop terminal.

Typically, the computer device 1500 includes: a processor 1501 and a memory 1502.

The processor 1501 may include one or more processing cores, such as a 4-core processor or an 8-core processor. The processor 1501 may be implemented in at least one hardware form of a digital signal processor (DSP), a field-programmable gate array (FPGA), and a programmable logic array (PLA). The memory 1502 may include one or more computer-readable storage media. The computer-readable storage media may be non-transitory.

In some embodiments, the computer device 1500 further includes another component. A person skilled in the art appreciates that the structure shown in FIG. 15 does not limit the computer device 1500, and the computer device may include more or fewer components than those shown in the figure, or some components may be combined, or a different component deployment may be adopted.

In an embodiment, the computer-readable storage medium may include: a read-only memory (ROM), a random-access memory (RAM), a solid-state drive (SSD), an optical disc, or the like. The RAM may include a resistive random-access memory (ReRAM) and a dynamic random-access memory (DRAM). The serial numbers of the embodiments in the present disclosure are for descriptive purposes only and do not indicate the superiority or inferiority of any embodiment.

The embodiments of the present disclosure further provide a computer device. The computer device includes a processor and a memory, the memory has at least one instruction, at least one program, a code set, or an instruction set stored therein, and the at least one instruction, the at least one program, the code set, or the instruction set is loaded and executed by the processor to implement the information display method according to any one of the foregoing embodiments of the present disclosure.

The embodiments of the present disclosure further provide a computer-readable storage medium. The storage medium has at least one instruction, at least one program, a code set, or an instruction set stored therein, the at least one instruction, the at least one program, the code set, or the instruction set is loaded and executed by a processor to implement the information display method according to any one of the foregoing embodiments of the present disclosure.

The embodiments of the present disclosure further provide a computer program product or a computer program. The computer program product or the computer program includes computer instructions, and the computer instructions are stored in a computer-readable storage medium. A processor of a computer device reads the computer instructions from the computer-readable storage medium and executes the computer instructions, to cause the computer device to perform the information display method according to any one of the foregoing embodiments.

A person of ordinary skill in the art appreciate that all or some of the operations of the foregoing embodiments may be implemented by hardware, or may be implemented by a program instructing relevant hardware. The program may be stored in a computer-readable storage medium. The foregoing storage medium may be an ROM, a magnetic disk, an optical disc, or the like.

The foregoing descriptions are merely preferred embodiments of the present disclosure, but are not intended to limit the present disclosure. Any modification, equivalent substitution, improvement, or the like made within the spirit and principle of the present disclosure fall within the scope of protection of the present disclosure.

What is claimed is:

1. An information display method, performed by a computer device, the method comprising:
displaying a match interface between a host account and an opponent account in a board game, the match interface comprising a plurality of virtual pieces; a host virtual piece being a virtual piece redeemed by the host account, and the host virtual piece being configured to engage in virtual game battle against an opponent virtual piece redeemed by the opponent account;
displaying quantity information of a first virtual piece in response to receiving a selection operation for the first virtual piece in the plurality of virtual pieces, the quantity information comprising a total quantity of first virtual pieces redeemed by the host account and the opponent account; and
updating and displaying, in response to an exchange event of the host account or the opponent account for the first virtual piece, the quantity information corresponding to the first virtual piece.

2. The method according to claim 1, wherein the quantity information further comprises a first exchange quantity of first virtual pieces redeemed by the host account.

3. The method according to claim 1, wherein the displaying quantity information of a first virtual piece in response to receiving a selection operation for the first virtual piece in the plurality of virtual pieces comprises:
persistently displaying the quantity information of the first virtual piece on the match interface in response to receiving the selection operation for the first virtual piece.

4. The method according to claim 1, wherein the persistently displaying the quantity information of the first virtual piece on the match interface in response to receiving the selection operation for the first virtual piece comprises:
receiving a trigger operation for a quantity display control on the match interface, the trigger operation being configured to control a virtual piece to be in a candidate state; and
persistently displaying, in response to receiving the selection operation for the first virtual piece, the quantity information of the first virtual piece in a control area corresponding to the quantity display control.

5. The method according to claim 1, further comprising:
displaying text prompt information of the first virtual piece in response to receiving a text trigger operation for the control area, the text prompt information presenting the quantity information in a text form.

6. The method according to claim 1, wherein the displaying quantity information of a first virtual piece in response to receiving a selection operation for the first virtual piece in the plurality of virtual pieces comprises:
displaying, in response to receiving the selection operation for the first virtual piece, a piece information display area corresponding to the first virtual piece, the piece information display area comprising the quantity information of the first virtual piece.

7. The method according to claim 1, further comprising:
displaying an exchange account list of the first virtual piece, the exchange account list comprising a first account that is in the opponent account and that redeems the first virtual piece;
displaying, in response to receiving a marking operation for t first account in the exchange account list, a second exchange quantity of first virtual pieces redeemed by the first account.

8. The method according to claim 1, wherein the match interface comprises a game battle area and a game battle preparation area, the game battle area is an area where an auto battler match is conducted between the opponent account and the host account, and the game battle preparation area is an area where the opponent account and the host account make preparations before the auto battler match starts; and
the displaying quantity information of a first virtual piece in response to receiving a selection operation for the first virtual piece in the plurality of virtual pieces comprises:
displaying the quantity information of the first virtual piece in response to receiving a selection operation for the first virtual piece in the game battle preparation area or the game battle area; or
displaying the quantity information of the first virtual piece in response to receiving a selection operation for the first virtual piece in a preset piece list, the preset piece list comprising at least one of a user-defined piece list or a piece exchange area, and a candidate piece in the preset piece list comprising at least one of the following: a virtual piece with usage frequency meeting a preset requirement, a virtual piece with exchange frequency meeting a preset requirement, or a user-defined virtual piece.

9. The method according to claim 1, further comprising:
displaying, in response to that the quantity of first virtual pieces redeemed by the host account meets a preset quantity requirement, an upgraded virtual piece synthesized from a plurality of first virtual pieces, attribute information of the upgraded virtual piece being different from attribute information of the first virtual piece,
in response to that the plurality of first virtual pieces are synthesized into the upgraded virtual piece, displaying statistical data before synthesis as the quantity information of the first virtual piece.

10. The method according to claim 9, further comprising:
displaying high-tier quantity information in the quantity information after the plurality of first virtual pieces are synthesized into the upgraded virtual piece, the high-tier quantity information indicating a total quantity of upgraded virtual pieces synthesized by the host account and the opponent account.

11. The method according to claim 1, further comprising:
canceling, in response to receiving a deselection operation for the first virtual piece, display of the quantity information of the first virtual piece in the control area corresponding to the quantity display control.

12. The method according to claim 1, further comprising:
receiving an exchange lock operation for the first virtual piece in response to that an account level of the host account meets a preset level requirement, the exchange lock operation being configured to lock the first virtual piece in a piece pool, and the locked first virtual piece in the piece pool being incapable of being redeemed by either the host account or the opponent account; and
displaying locked quantity information in the quantity information, the locked quantity information indicating a total quantity of first virtual pieces in the piece pool that are locked by the host account and the opponent account.

13. An information display apparatus, comprising:
a processor and a memory, the memory having at least one program stored therein, and the at least one program being loaded and executed by the processor; and the processor being configured, when loading and executing the at least one program, to:
display a match interface between a host account and an opponent account in a board game, the match interface comprising a plurality of virtual pieces; a host virtual piece being a virtual piece redeemed by the host account, and the host virtual piece being configured to engage in virtual game battle against an opponent virtual piece redeemed by the opponent account,
display quantity information of a first virtual piece in response to receiving a selection operation for the first virtual piece in the plurality of virtual pieces, the quantity information comprising a total quantity of first virtual pieces redeemed by the host account and the opponent account; and
update and display, in response to an exchange event of the host account or the opponent account for the first virtual piece, the quantity information corresponding to the first virtual piece.

14. The apparatus according to claim 13, wherein
the quantity information further comprises a first exchange quantity of first virtual pieces redeemed by the host account.

15. The apparatus according to claim 13, wherein
the processor is further configured to persistently display the quantity information of the first virtual piece on the match interface in response to receiving the selection operation for the first virtual piece.

16. The apparatus according to claim 13, wherein
the processor is further configured to receive a trigger operation for a quantity display control on the match interface, the trigger operation being configured to control a virtual piece to be in a candidate state; and persistently display, in response to receiving the selection operation for the first virtual piece, the quantity information of the first virtual piece in a control area corresponding to the quantity display control.

17. The apparatus according to claim 13, wherein
the processor is further configured to display text prompt information of the first virtual piece in response to receiving a text trigger operation for the control area, the text prompt information presenting the quantity information in a text form.

18. The apparatus according to claim 13, wherein the displaying quantity information of a first virtual piece in response to receiving a selection operation for the first virtual piece in the plurality of virtual pieces comprises:
displaying, in response to receiving the selection operation for the first virtual piece, a piece information display area corresponding to the first virtual piece, the piece information display area comprising the quantity information of the first virtual piece.

19. The apparatus according to claim 13, wherein the processor is further configured to:
display an exchange account list of the first virtual piece, the exchange account list comprising a first account that is in the opponent account and that redeems the first virtual piece;
display, in response to receiving a marking operation for t first account in the exchange account list, a second exchange quantity of first virtual pieces redeemed by the first account.

20. A non-transitory computer-readable storage medium, the storage medium having at least one program stored therein, and the at least one program being loaded and executed by a processor to implement:
displaying a match interface between a host account and an opponent account in a board game, the match interface comprising a plurality of virtual pieces; a host virtual piece being a virtual piece redeemed by the host account, and the host virtual piece being configured to engage in virtual game battle against an opponent virtual piece redeemed by the opponent account;
displaying quantity information of a first virtual piece in response to receiving a selection operation for the first virtual piece in the plurality of virtual pieces, the quantity information comprising a total quantity of first virtual pieces redeemed by the host account and the opponent account; and
updating and displaying, in response to an exchange event of the host account or the opponent account for the first virtual piece, the quantity information corresponding to the first virtual piece.
